(19) United States
(12) Patent Application Publication
(10) Pub. No.: US 2025/0302192 A1
(43) Pub. Date: Oct. 2, 2025

(54) PROJECTION SYSTEM

(71) Applicant: SEIKO EPSON CORPORATION, Tokyo (JP)

(72) Inventors: Yoichi FUJIKAWA, AZUMINO-SHI (JP); Ippei KUROTA, MATSUMOTO-SHI (JP); Akira MOMOSE, SHIOJIRI-SHI (JP)

(21) Appl. No.: 19/097,262

(22) Filed: Apr. 1, 2025

(30) Foreign Application Priority Data
Apr. 2, 2024 (JP) 2024-059801

(51) Int. Cl. A47B 81/06; G03B 21/16

(52) U.S. Cl. CPC A47B 81/06; G03B 21/16

(57) ABSTRACT

The projection system includes a projector that emits light as a projection image to be projected on a projection surface; a projection cabinet housing the projector; and a holding member on which an object is placed, wherein the projection cabinet includes a housing with a first opening arranged in accordance with configuration of the projector and a second opening for a user to grip the projection cabinet and an installation section disposed in the housing and on which the projector is installed and the holding member is detachably attached to at least one of the first opening or the second opening.

The present application is based on, and claims priority from JP Application Serial Number 2024-059801, filed Apr. 2, 2024, the disclosure of which is hereby incorporated by reference herein in its entirety.

### BACKGROUND

### 1. Technical Field

The present disclosure relates to a projection system.

### 2. Related Art

Cabinets described in JP-A-2000-287764 and JP-A-2003-009967 are known as a piece of furniture that can be moved with a projector placed thereon. The cabinet described in JP-A-2000-287764 adopts a configuration in which the projector is placed on the top plate in a state in which an operation device for operating the projector is placed on an internal shelf plate. The cabinet described in JP-A-2003-009967 adopts a configuration in which an article such as an operation device is held by a holding member attached to a plurality of attachment holes provided in a side plate of the cabinet main body.

With respect to the cabinet described in JP-A-2000-287764, when the operation device inside the cabinet is to be operated, it is necessary to move the projector from the top plate.

Therefore, it takes time and effort to access the operation device, which is inconvenient for the user. With respect to the cabinet described in JP-A-2003-009967, the design appearance of the cabinet is impaired by the plurality of attachment holes provided in the cabinet main body.

### SUMMARY

In order to overcome the above problems, according to an aspect of the present disclosure, a projection system includes a projector that emits light as a projection image to be projected on a projection surface; a projection cabinet housing the projector; and a holding member on which an object is placed, wherein the projection cabinet includes a housing with a first opening arranged in accordance with configuration of the projector and a second opening for a user to grip the projection cabinet and an installation section disposed in the housing and on which the projector is installed and the holding member is detachably attached to at least one of the first opening or the second opening.

### BRIEF DESCRIPTION OF THE DRAWINGS

FIG. 1 is a front surface perspective view showing configuration and an installation mode of a projection system according to a first embodiment.

FIG. 2 is a back surface perspective view showing schematic configuration and the installation mode of the projection system.

FIG. 3 is a right side surface view showing schematic configuration and the installation mode of the projection system.

FIG. 4 is a top view showing schematic configuration and the installation mode of the projection system.

FIG. 5 is an exploded perspective view of a projection cabinet.

FIG. 6 is an exploded perspective view of a cabinet main body.

FIG. 7 is a front surface perspective view showing schematic configuration of the projection cabinet.

FIG. 8 is a back surface perspective view showing schematic configuration of the projection cabinet.

FIG. 9 is an enlarged right side surface view of a protrusion.

FIG. 10 is a perspective view showing configuration of a holding member.

FIG. 11 is a cross-sectional view showing a state in which the holding member is attached to a first hole.

FIG. 12 is a plan view of an operation panel.

FIG. 13 is a block diagram showing configuration of a controller.

FIG. 14 is a diagram showing an example of cabling of the projection cabinet.

FIG. 15A is a perspective view showing schematic configuration of a holding member of a second embodiment.

FIG. 15B is a cross-sectional view showing a state in which the holding member is attached to the cabinet main body.

FIG. 16A is a perspective view showing schematic configuration of a holding member of the third embodiment.

FIG. 16B is a cross-sectional view showing a state in which the holding member is attached to the cabinet main body.

### DESCRIPTION OF EMBODIMENTS

Hereinafter, embodiments of the present disclosure will be described with reference to the drawings.

In each of the following drawings, in order to make each component easy to see, the scale of the size may be different depending on the component.

Hereinafter, for convenience of description, three axes orthogonal to each other are referred to as an X-axis, a Y-axis, and a Z-axis, and a direction parallel to the X-axis is referred to as an “X-axis direction”, a direction parallel to the Y-axis is referred to as a “Y-axis direction”, and a direction parallel to the Z-axis is referred to as a “Z-axis direction”. The tip end side of each axis in the arrow direction is also referred to as a “plus side”, and the opposite side is also referred to as a “minus side”. Hereinafter, a surface on the minus side in the X-axis direction is referred to as a “front surface”, a surface on the plus side in the X-axis direction is referred to as a “back surface”, a surface on the minus side in the Y-axis direction is referred to as a “left side surface”, a surface on the plus side in the Y-axis direction is referred to as a “right side surface”, a surface on the plus side in the Z-axis direction is referred to as an “upper surface”, and a surface on the minus side in the Z-axis direction is referred to as a “lower surface”.

### First Embodiment

An embodiment of the projection system of the present disclosure will be described with reference to the drawings.

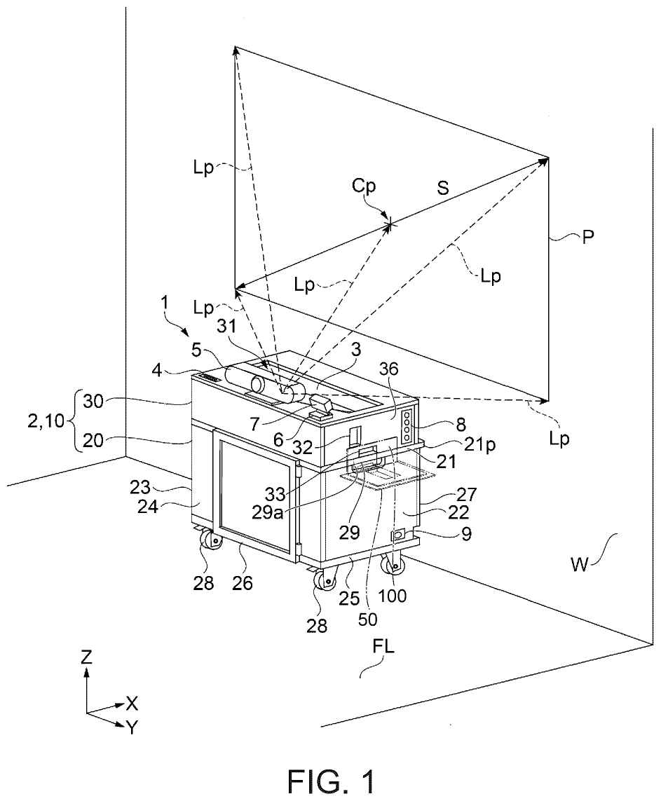

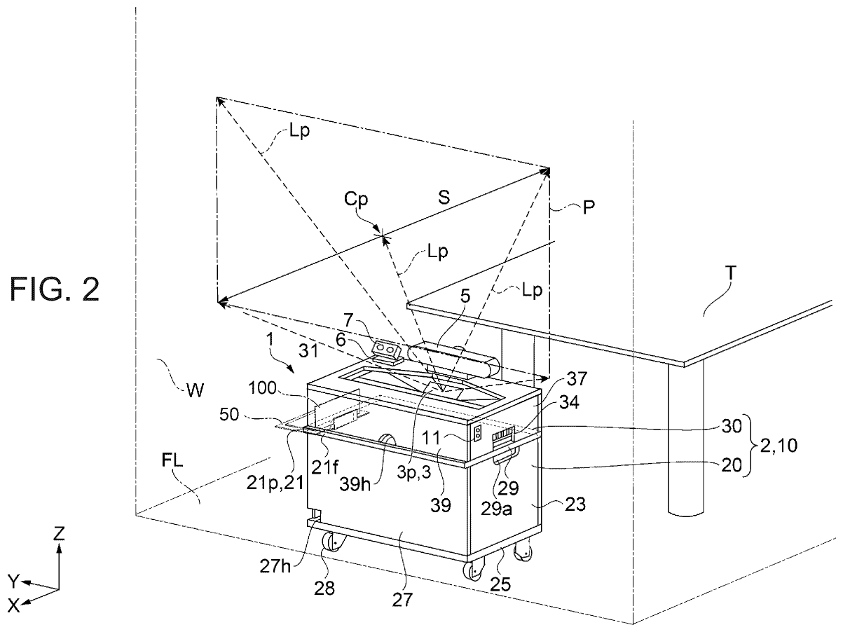

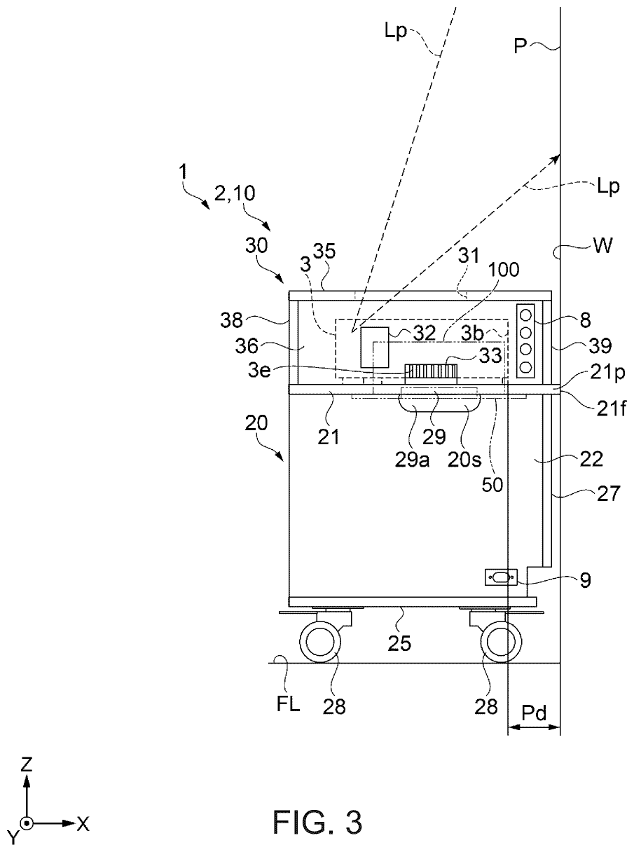

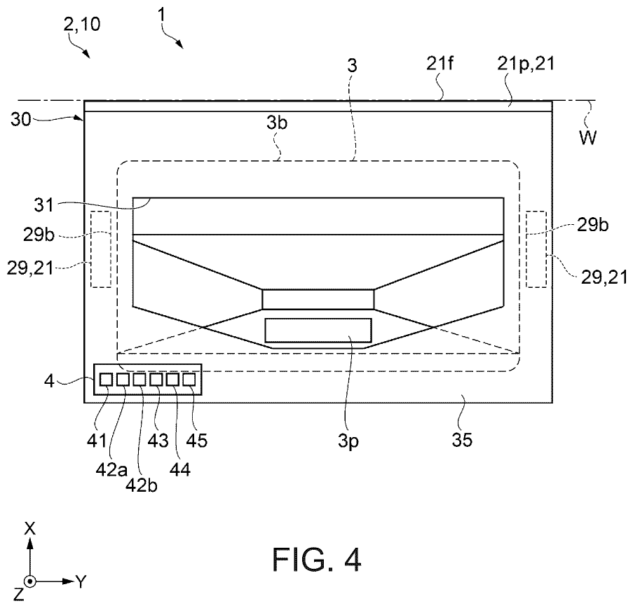

FIG. 1 is a front surface perspective view showing schematic configuration and an installation mode of a projection system 1 of the present embodiment. FIG. 2 is a back surface perspective view showing schematic configuration and the installation mode of the projection system 1. FIG. 3 is a right side surface view showing schematic configuration and the installation mode of the projection system 1. FIG. 4 is an upper surface view showing schematic configuration and the installation mode of projection system 1. Note that in FIGS. 3 and 4, description of a Web camera 5, a controller 6, a correction unit 7, and a holding member 50 (to be described later) is omitted.

As shown in FIG. 1 or FIG. 2, the projection system 1 includes a projection cabinet 2, a projector 3 mounted on the projection cabinet 2, and a holding member 50 on which is mounted an output device 100 for outputting a predetermined signal to the projector 3. The projection cabinet 2 can also be referred to as a piece of furniture. For example, a personal computer or a portable terminal device, such as a tablet or a smartphone, is used as the output device 100.

The projection cabinet 2 includes a cabinet main body 10 and an operation panel 4. In the present embodiment, the cabinet main body 10 is an example of a housing. In the present embodiment, the output device 100 is an example of an object. That is, the output device 100, which is an example of an object in the present embodiment, is a control body operated by a user who is a user of the projection system 1.

The cabinet main body 10 includes a lower assembly 20 and an upper assembly 30, and has a box shape as a whole.

The holding member 50 is detachably attached to the cabinet main body 10. The configuration of the holding member 50 will be described later.

The projector 3 is accommodated between the lower assembly 20 and the upper assembly 30. More specifically, the projector 3 is installed on the upper surface of the lower assembly 20 and is housed in a state of being surrounded by the upper assembly 30 on the upper side and the four sides. In the present embodiment, the lower assembly 20 is an example of an installation section.

A projection port 31 is provided on the upper surface of the upper assembly 30. The projection port 31 is an opening section provided to enable projection light Lp emitted from a projection light source 3p of the projector 3 to pass through. In other words, the projection port 31 is an opening section arranged in accordance with the function of the projector 3. In the present embodiment, the projection port 31 is an example of a first opening.

The projection cabinet 2 has casters 28 at the four corners of the lower surface of the lower assembly 20. When the casters 28 are unlocked, the user of the projection system 1 can move the projection cabinet 2 to a desired location. For example, the user can move the projection cabinet 2 from a living room to a conference room or from one conference room to another conference room.

The user installs the projection cabinet 2 at a predetermined projection position in the conference room. At this time, the projection cabinet 2 is installed so that its back surface faces the wall surface W.

To be specific, as shown in FIGS. 3 and 4, the user moves the projection cabinet 2 to bring the entire surface of the end surface 21f of a protrusion 21p of the lower assembly 20 into contact with the wall surface W.

The position where the entire surface of the end surface 21f of the protrusion 21p of the lower assembly 20 abuts on the wall surface W is a predetermined projection position. In the present embodiment, the position where the protrusion 21p of the lower assembly 20 abuts on the wall surface W is an example of a predetermined position where the projector 3 displays a projection image P on the wall surface W, which serves as a projection surface. Note that the predetermined position can also be referred to as a predetermined projection position.

As shown in FIG. 1 or FIG. 2, after the projection cabinet 2 is installed at the predetermined projection position, the projector 3 is activated to project projection light Lp from the projection light source 3p toward the wall surface W. In the present embodiment, the wall surface W is an example of a projection surface. The projection surface is not limited to the wall surface W. The projection surface is not limited to a flat surface of a rigid body, and may be a curtain formed of cloth or a sheet.

As shown in FIG. 2 or 4, the projection light source 3p is a portion from which projection light Lp generated inside the projector 3 is emitted to the outside of the housing of the projector 3. In other words, the projection light source 3p is an emission port from which the projector 3 emits the projection light Lp. The projection light source 3p is preferably covered with a translucent plate made of glass, synthetic resin, or the like, but it may also be an opening.

As shown in FIG. 1 or FIG. 2, when projection light Lp is projected from the projection light source 3p of the projector 3 onto the wall surface W, a projection image P is displayed on the wall surface W. In the present embodiment, the projection light Lp is an example of light.

The screen size S of the projection image P is, for example, 80 inches. The screen size S is not limited to 80 inches. For example, it may be 100 inches or 120 inches. The projection image P is rectangular. That is, the lengths of the diagonal lines of the projection image P are equal to each other, and the middle point of the diagonal lines of the projection image P coincides with the image center Cp.

In the present embodiment, the upper surface of the lower assembly 20 is specifically the upper surface of a base 21. Note that the upper surface of the lower assembly 20 or the upper surface of the base 21 is an example of an installation surface on which the projector 3 is installed. When the height of the installation surface on which the projector 3 is installed is set to the same value as the height of a conference room table T, it is possible to enhance the sense of unity with table T.

Next, configuration of the projection cabinet 2 will be described.

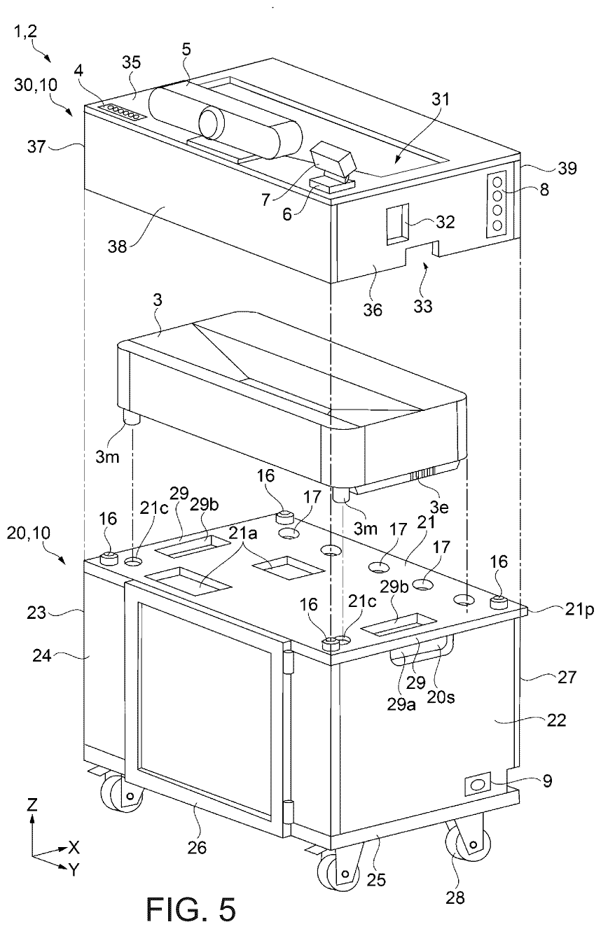

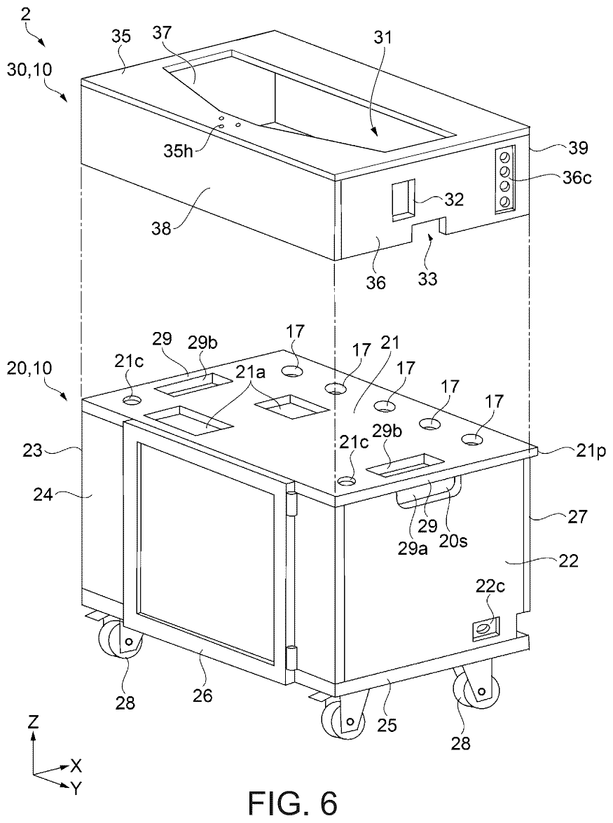

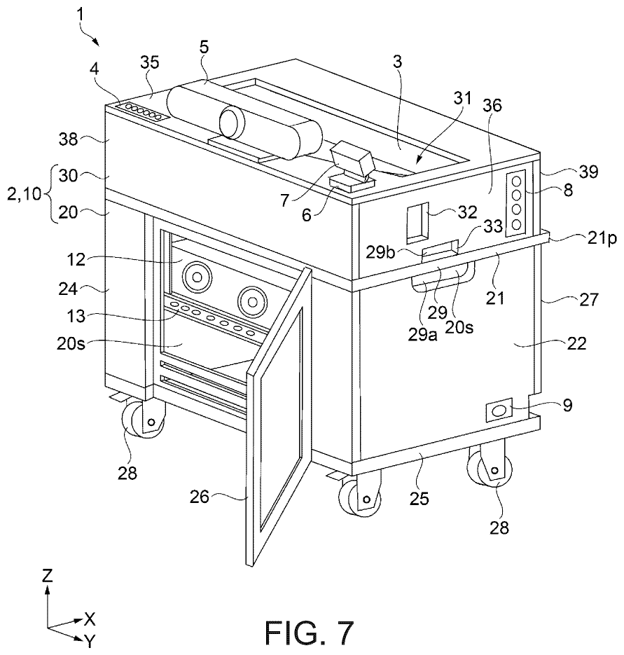

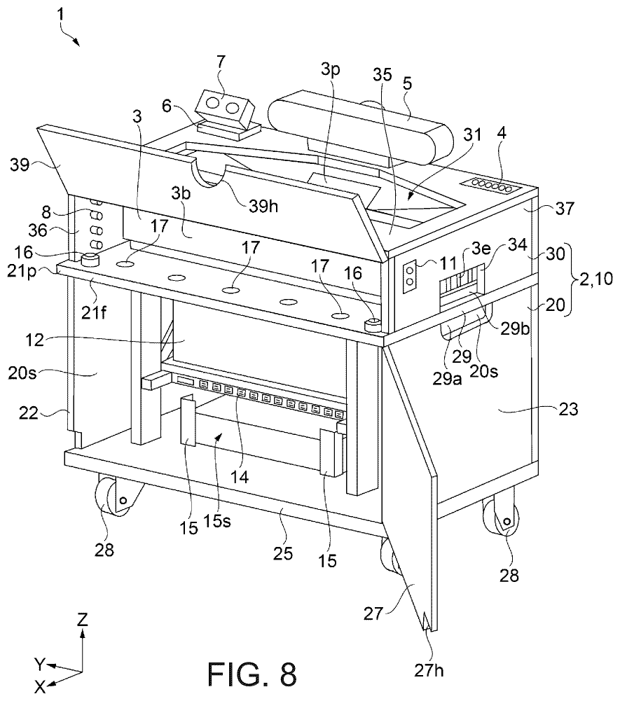

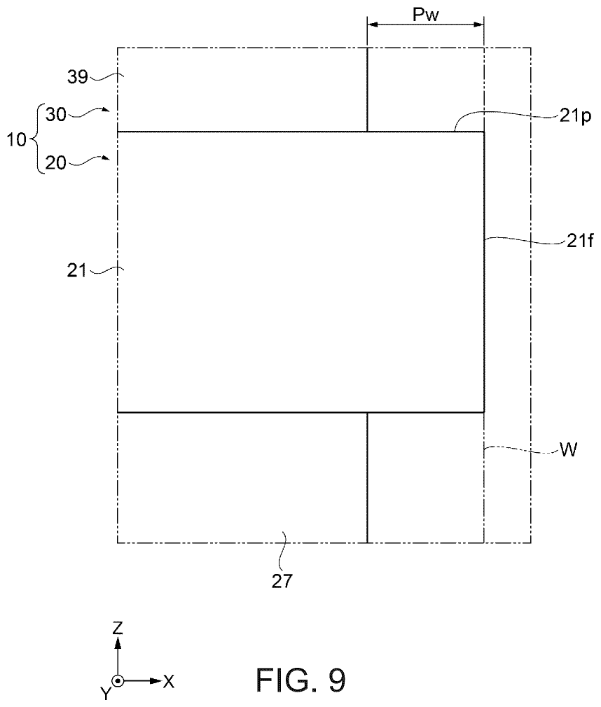

FIG. 5 is an exploded perspective view of the projection cabinet 2. FIG. 6 is an exploded perspective view of the cabinet main body 10. FIG. 7 is a front surface perspective view of the projection cabinet 2. FIG. 8 is a back surface perspective view of the projection cabinet 2. FIG. 9 is an enlarged right side surface view of the protrusion 21p. Note that in FIGS. 5 to 9, description of the holding member 50 is omitted.

As shown in FIG. 5, the projection cabinet 2 includes the cabinet main body 10 and the operation panel 4.

As shown in FIG. 6, the cabinet main body 10 is composed of a lower assembly 20 and an upper assembly 30, and the lower assembly 20 and the upper assembly 30 are assembled in a manner that enables their disassembly in consideration of ease of maintenance.

A fixing section such as a metal fitting is used to assemble the lower assembly 20 and the upper assembly 30. Note that the fixing section is provided at a position that is not visible from the outside, so as not to impair the external appearance. External appearance can also be referred to as aesthetics.

As shown in FIGS. 5 and 6, the lower assembly 20 has a rectangular parallelepiped shape whose six surfaces are surrounded by the base 21, a right side plate 22, a left side plate 23, a front plate 24, a front cover 26, a bottom plate 25, and a back lower cover 27. The casters 28 are provided at the four corners of the lower surface of the bottom plate 25.

The two casters 28 on the front surface side are locked, and the two casters 28 on the back surface side are not locked. As will be described later, since the projection cabinet 2 can be carried by handles 29, it may be configured without attaching the casters 28.

As shown in FIGS. 7 and 8, an accommodation space 20s is provided inside the lower assembly 20. The accommodation space 20s can be accessed through a front cover 26 provided on a front surface of the lower assembly 20 so as to be openable and closable, or a back lower cover 27 provided on a back surface of the lower assembly 20 so as to be openable and closable.

As shown in FIG. 7, by opening the front cover 26, the user can access a speaker 12 and an inner image interface (IF) 13, which are accommodated in the accommodation space 20s, from the front surface of the projection cabinet 2.

The inner image IF 13 is a video and/or an audio interface, and has interfaces such as a musical instrument digital interface (MIDI) or universal serial bus (USB). The inner image IF 13 is connected to the audio visual (AV) input port 8 provided in the upper assembly 30 and a predetermined signal, including a video signal or an audio signal, is supplied from the output device 100 placed on the holding member 50 shown in FIG. 1 via the AV input port 8. The output device 100 and the AV input port 8 may be connected by either a wired or wireless method. The speaker 12 is an AV device capable of outputting a loud volume. In the present embodiment, the speaker 12 is installed in the accommodation space 20s in a state of being attached to a 19-inch rack shelf.

The speaker 12 is designed to be used in situations where a loud volume is necessary, such as in a large conference room or an open space. Therefore, when a loud volume is not required, the speaker 12 may not need to be accommodated.

As shown in FIG. 8, by opening the back lower cover 27, the user can access an internal power supply tap 14, which is accommodated in the accommodation space 20s, from the back surface of the projection cabinet 2. A cutout 27h provided in the back lower cover 27 can be used as a handle when opening the back lower cover 27.

Power cords of the projector 3, the speaker 12, the power feed port 11 provided in the upper assembly 30, the Web camera 5, and the like are connected to the internal power supply tap 14 and AC power is supplied from an outlet (not shown) via an alternating current (AC) inlet 9 provided in the right side plate 22.

The accommodation space 20s is provided with rack mount angles 15 for forming a 19 inch rack space 15s conforming to Electronic Industries Alliance (EIA) standards. In the 19 inch rack space 15s, 19-inch devices, such as conference system equipment and batteries, are stored.

As shown in FIGS. 5 and 6, the base 21 is the top plate of the lower assembly 20.

The projector 3 is installed on the upper surface of the base 21. In other words, the base 21 has an installation surface on which the projector 3 is installed.

The base 21 includes fixing sections 21c, through holes 21a, the protrusion 21p, the handles 29, wiring holes 17, and supporters 16.

The fixing sections 21c are provided to fix the projector 3 to the upper surface of the base 21. Since the projector 3 has the fixing sections 21c, displacement of the installation position of the projector 3 inside the projection cabinet 2 due to movement or the like of the projection cabinet 2 is suppressed.

The fixing sections 21c are provided at two positions corresponding to the positions of legs 3m of the projector 3.

In the present embodiment, the fixing sections 21c are recesses. The projector 3 is fixed by fitting the distal ends of the legs 3m of the projector 3 into the recesses. The fixing sections 21c are not limited to being recesses. For example, they may be through holes, L-shaped columnar bodies, angles, brackets, or the like. The number of places where the fixing sections 21c are disposed is not limited to two. The number of fixing sections 21c necessary for suppressing the positional deviation of the projector 3 may be provided at necessary positions.

The through holes 21a are openings for the air intake of the projector 3 and are provided at positions on the base 21 corresponding to the air intake ports of the projector 3.

The through holes 21a allow the projector 3 to stably intake the amount of air necessary and sufficient for cooling through the through holes 21a.

In the present embodiment, since the projector 3 has intake ports at two positions of the center and the front surface side of the bottom surface, the through holes 21a are also provided at two positions corresponding to the intake ports. A through hole 21a provided at a single position may be constituted by a plurality of through holes or slits formed by punching or slitting.

The protrusion 21p is a portion on the back surface side of the base 21, and is the portion of the cabinet main body 10 that protrudes most to the plus side in the X-axis direction.

As shown in FIG. 9, the protrusion 21p projects by a length Pw from the back surface of the back lower cover 27 or a back plate 39 of the upper assembly 30. In the present embodiment, the width Pw is not less than 2 mm and not more than 5 mm. By setting the width Pw to be greater than or equal to 2 mm and less than or equal to 5 mm, it is possible to minimize the influence on the external appearance.

The end surface 21f of the protrusion 21p constitutes a reference surface when positioning the projector 3 at a predetermined projection position. In the present embodiment, the end surface 21f is a continuous flat surface as shown in FIG. 4. The end surface 21f is not limited to a flat surface. The end surface 21f may have irregularities as long as it can serve as a reference surface.

In the projection cabinet 2 of the present embodiment, the protrusion 21p used when positioning the projector 3 at a predetermined projection position is provided integrally with the base 21. The projector 3 is installed on the base 21. In other words, the only component provided between the wall surface W where the protrusion 21p abuts and the projector 3 is the base 21.

Therefore, it is possible to reduce the possibility of manufacturing variations and assembly errors. Furthermore, it is also possible to suppress the possibility of rattling due to use or aging. Therefore, the reliability of the alignment accuracy can be improved.

As shown in FIGS. 5 and 6, the handles 29 are provided on both the left and right sides of the base 21. The handles 29 are used to move the projection cabinet 2. For example, where there is a step that the casters 28 cannot cross, the user can grasp the handles 29 by hand and lift the projection cabinet 2 to cross the step.

The right side handle 29 is configured by a portion between a first hole 29a that is a through hole provided in the right side plate 22 and a second hole 29b that is a through hole provided in the base 21. The left side handle 29 is constituted by a portion between a first hole 29a that is a through hole provided in the left side plate 23 shown in FIG. 8 and a second hole 29b that is a through hole provided in the base 21.

As shown in FIGS. 5 and 6, the first hole 29a and the second hole 29b are in communication with each other through the accommodation space 20s of the lower assembly 20, and the user can grasp the handles 29 by hand by inserting the user's finger into the first hole 29a and protruding the fingertips from the second hole 29b. That is, in the present embodiment, the first hole 29a is an example of a second opening for the user to grip the projection cabinet 2.

In this embodiment, the holding member 50 is detachably attached to the first hole 29a. With the wall surface W, which is the projection surface, as the front surface, the first holes 29a are disposed on both the left and right sides of the cabinet main body 10. For this reason, when attaching the holding member 50, the holding member 50 is positioned on the side of the cabinet main body 10, and so can suppress occurrence of issues such as the holding member 50 being placed between the wall surface W and the projection cabinet 2, or between the projection cabinet 2 and the user, where it could become an obstruction.

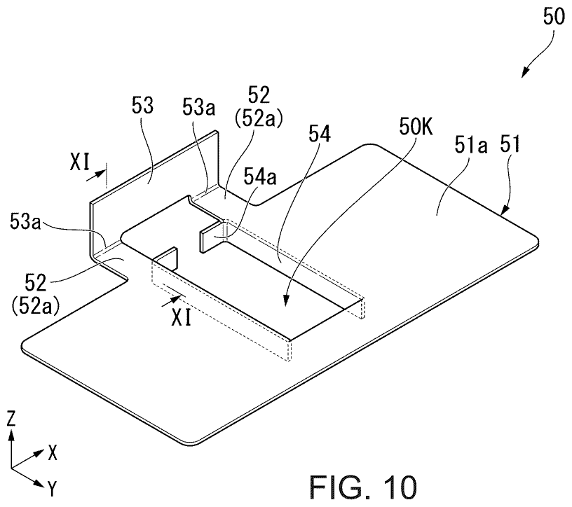

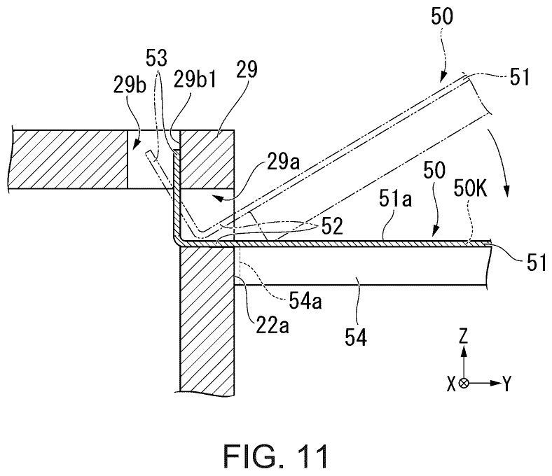

FIG. 10 is a perspective view showing configuration of the holding member 50. FIG. 11 is a cross-sectional view showing a state where the holding member 50 is attached to the first hole 29a. FIG. 11 is a cross-sectional view taken along line XI-XI of FIG. 10.

As shown in FIGS. 10 and 11, the holding member 50 includes a holding section 51, an insertion section 52, a first latching section 53, and a second latching section 54. The holding member 50 is formed of a single metal plate that has undergone a bending process. By this, the weight and cost of the holding member 50 can be reduced.

The holding section 51 includes a holding surface 51a on which the output device 100 is placed and held, and a rectangular through hole port 50K penetrating the holding surface 51a. Therefore, the holding surface 51a has a substantially U-shaped configuration. The through hole port 50K exposes the bottom surface side of the output device 100 placed on the holding surface 51a, so that, for example, a cable drawn out from the output device 100 can be inserted through the through hole port 50K. The through hole port 50K can improve the heat dissipation of the output device 100 by exposing the bottom surface side of the output device 100.

The insertion section 52 extends from the holding section 51 along the Y-axis direction along the holding surface 51a and is inserted into the first hole 29a. The through hole port 50K also penetrates through the insertion section 52. Therefore, the insertion section 52 is constituted by a pair of plate members 52a spaced apart from each other in the X-axis direction. The pair of plate members 52a are connected to the ends 53a of the rectangular first latching section 53.

The first latching section 53 extends from the insertion section 52 along the Z-axis direction, which intersects the holding surface 51a, and abuts on the inner circumferential edge 29b1 of the second hole 29b. In the present embodiment, the inner circumferential edge 29b1 of the second hole 29b is an example of the inner wall of the housing.

Here, contact between the first latching section 53 and the inner circumferential edge 29b1 is not limited to a mode in which the first latching section 53 and the inner circumferential edge 29b1 are completely in contact with each other while the holding member 50 is attached to the first hole 29a, and includes a mode in which the first latching section 53 and the inner circumferential edge 29b1 are disposed to face each other with a predetermined clearance therebetween.

The second latching section 54 is provided on the −Z side of the holding surface 51a, which is opposite from the +Z side in which the first latching section 53 extends, and abuts against the outer surface 22a of the right side plate 22 at the proximal side of the insertion section 52. To be specific, the second latching section 54 is formed by bending a portion continuous with the holding section 51 to the −Z side, and is composed of a pair of plate members that form a part of the opening end of the through hole port 50K and that face each other in the X-axis direction. The second latching section 54 has bent sections 54a that bend toward the inside of the through hole port 50K on the proximal side of the insertion section 52. The bent sections 54a of the second latching section 54 are portions that abut against the outer surface 22a of the right side plate 22.

Here, contact between the second latching sections 54 and the outer surface 22a is not limited to a mode in which the second latching section 54 and the outer surface 22a are completely in contact with each other while the holding member 50 is attached to the first hole 29a, and includes a mode in which the second latching sections 54 and the outer surface 22a are disposed to face each other with a predetermined space therebetween. Note that the second hole 29b may be omitted if the first hole 29a is provided at a position below the position shown in FIG. 5, for example, at a position that enables a sufficiently large space to be secured from the first hole 29a to where the inserted first latching section 53 of the holding member 50 follows the inner wall of the right side plate 22. In this case, the inner wall of the right side plate 22 corresponds to the inner wall of the housing.

Next, a case where the holding member 50 is attached to the first hole 29a will be described.

As indicated by two dot chain line in FIG. 11, the first latching section 53 and the insertion section 52 are inserted into the first hole 29a in a state where the first latching section 53 is inclined toward the inside of the cabinet main body 10, and then the holding section 51 is returned to be horizontal. By this, the first latching section 53, which has risen vertically upright, comes into contact with the inner circumferential edge 29b1 of the second hole 29b and also the bent section 54a of the second latching section 54 comes into contact with the outer surface 22a of the right side plate 22. In this way, as indicated by solid line in FIG. 11, the holding member 50 is attached to the cabinet main body 10 by the first latching section 53 being latched to the inner circumferential edge 29b1 of the second hole 29b and the second latching section 54 being latched to the outer surface 22a of the right side plate 22.

On the other hand, when the holding member 50 is removed, the holding section 51 is inclined so as to approach the outer surface 22a of the right side plate 22, so that the first latching section 53 is separated from the inner circumferential edge 29b1 of the second hole 29b and the second latching section 54 is separated from the outer surface 22a of the right side plate 22. Then the first latching section 53 and the insertion section 52 are pulled out from the first hole 29a. By this, the holding member 50 can be easily removed from the cabinet main body 10.

As described above, according to the projection system 1 of the present embodiment, the holding section 51 can be easily attached to and detached from the cabinet main body 10.

As shown in FIGS. 5 and 6, the wiring holes 17 are holes for cabling. Five or six wiring holes 17 are disposed at the back surface 3b side of the projector 3. As described above, since a plurality of wiring holes 17 are provided on the base 21 on the back surface 3b side of the projector 3, the wiring work is easy, and beautiful cabling is possible.

Supporters 16 are provided the four corners of the upper surface of base 21 at positions for contacting the inner side of upper assembly 30. The supporters 16 are supports for receiving the load when the upper assembly 30 is pressed. Therefore, even if the user pushes the upper assembly 30, the entire projection cabinet 2, including the lower assembly 20, can be moved without difficulty.

As shown in FIG. 6, an attachment hole 22c is provided in the right side plate 22. The AC inlet 9 is attached to the attachment hole 22c. The AC inlet 9 is a connector for connecting an AC cable.

As shown in FIG. 5, the upper assembly 30 has a rectangular parallelepiped shape surrounded by a top plate 35, a right side plate 36, a left side plate 37, a front plate 38, and the back plate 39 on five surfaces except for the lower surface. The upper assembly 30 is fixed to the upper surface of the base 21.

The operation panel 4, the Web camera 5, the controller 6, and the correction unit 7 are provided on the upper surface of the top plate 35. An AV input port 8 is provided on the right side surface of the right side plate 36.

The projection port 31 is provided in the top plate 35, which forms the upper surface of the upper assembly 30. The projection port 31 is an opening for the projection light Lp of the projector 3. As described above, the projection light Lp emitted from the projection light source 3p passes through the projection port 31 and is displayed on the wall surface W, which serves as the projection surface. As shown in FIG. 4, the projection port 31 exposes the projection light source 3p of the projector 3 in a plan view.

As shown in FIG. 7, a cutout 33 provided in the right side plate 36 is an opening for exhaust of the projector 3, and is provided at a position corresponding to an exhaust port 3e on the right side surface of the projector 3. As shown in FIG. 8, a cutout 34 provided in the left side plate 37 is an opening for exhaust of the projector 3, and is provided at a position corresponding to an exhaust port 3e on the left side surface of the projector 3. In other words, it can be said that the cutout 34 is an opening section disposed in accordance with a function of the projector 3. In the present embodiment, the cutouts 33 and 34 are an example of a first opening.

By the cutout 33 and the cutout 34, the projector 3 can easily discharge air exhausted from the projector 3 to outside of projection cabinet 2 via the cutout 33 and the cutout 34. The cutout 33, the cutout 34, or both may be a through hole, or may be constituted by a plurality of through holes or slits formed by punching or slit processing.

As shown in FIG. 7, the opening 32 provided in the right side plate 36 is an opening for adjusting a focus lever of the projector 3, and is provided at a position corresponding to the focus lever of the projector 3. By providing the opening 32, the user can easily access the focus lever of the projector 3 and adjust focus of the projection image P. Therefore, the projection cabinet 2 of the present embodiment enables suppression of impairment of the operability of the projector 3.

In other words, the opening 32 is an opening section disposed in accordance with a function of the projector 3. In the present embodiment, the opening 32 is an example of a first opening.

As shown in FIG. 6, the upper assembly 30 has attachment holes 35h and attachment holes 36c.

The attachment holes 35h are provided in the top plate 35. The Web camera 5 is fixed to the top plate 35 using the attachment holes 35h. A Web camera is a video conference device equipped with a camera, a microphone, and a speaker.

The attachment holes 36c are provided in the right side plate 36. The AV input port 8 is attached to the attachment holes 36c. The AV input port 8 is composed of an HDMI (High Definition Multimedia Interface, registered trademark) connector, a USB (Universal Serial Bus) connector, or the like.

As shown in FIG. 8, the power feed port 11 is attached to the left side plate 37. The power feed port 11 is mounted by using an attachment hole (not shown). The power feed port 11 is a port for USB power supply.

As shown in FIG. 8, the back plate 39 is attached to the top plate 35 in an openable and closable manner. A user can open the back plate 39 by using a cutout 39h in the back plate 39.

When the back plate 39 is in the open state, a large opening can be provided on the back surface of the upper assembly 30. By using the opening, the user can easily perform maintenance of the projector 3 and wiring work that use the wiring holes 17.

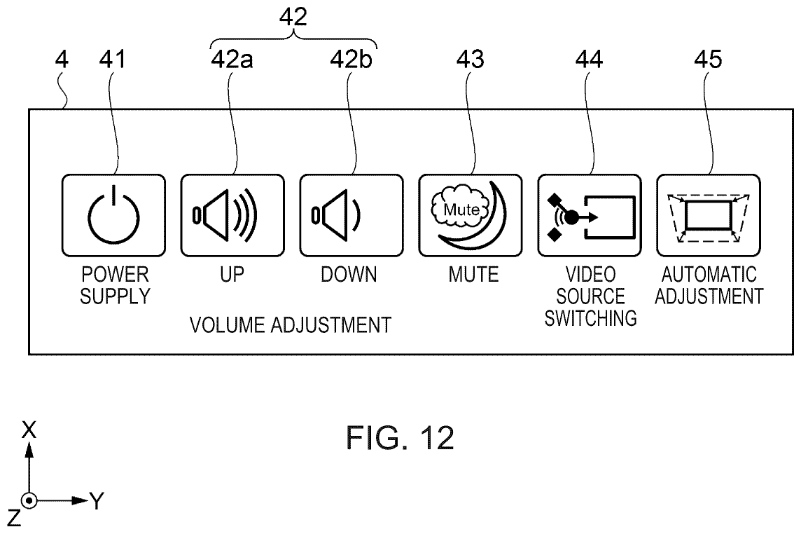

FIG. 12 is a plan view of the operation panel 4. As shown in FIG. 12, the operation panel 4 has operation buttons 41, 42a, 42b, 43, 44, and 45 for controlling the projector 3, the speaker 12, or both. In the present embodiment, the operation buttons 41, 42a, 42b, 43, 44, and 45 are examples of operation elements.

The operation buttons 41, 42a, 42b, 43, 44, and 45 are operation buttons corresponding to the five kinds of functions of power supply, volume adjustment, mute, video source switching, and automatic adjustment.

In the present embodiment, the above-described five types of functions are selected from the viewpoint of frequency of use.

The power supply includes a function of turning on the power supply of the projector 3 and the speaker 12 and a function of turning off the power supply of the projector 3 and the speaker 12, and a single operation button 41 is provided corresponding to these two functions. The operation button 41 is a power button.

By clicking the operation button 41, power-on is executed. Specifically, the projector 3 and the speaker 12 transition from a standby state to an activated state. By pressing and holding the operation button 41, power-off is executed. Specifically, the projector 3 and the speaker 12 transition from the activated state to the standby state.

Volume adjustment includes a function of increasing the volume of speaker 12 by one unit, a function of decreasing the volume by one unit, a function of continuously increasing the volume, and a function of continuously decreasing the volume, and two operation buttons 42 are provided corresponding to these four functions. The operation button 42a is a volume UP button, and the operation button 42b is a volume DOWN button.

By clicking the operation button 42a, the volumes of the projector 3 and the speaker 12 are increased by one unit. By pressing and holding down the operation button 42a, the sound volume continuously increases. By clicking the operation button 42b, the volume decreases by one unit. By pressing and holding down the operation button 42b, the volume continuously decreases.

The mute includes a function of setting the projector 3 and the speaker 12 to a mute state and a function of canceling the mute state, and a single operation button 43 is provided corresponding to these two functions. The operation button 43 is a mute button.

By clicking the operation button 43, muting is executed. By clicking the operation button 43 while in the mute state, the mute state is released.

The video source switching is a function of switching the video source of the projector 3, and a single operation button 44 is provided corresponding to this function. The operation button 44 is a video source switching button.

When the operation button 44 is clicked, the video source is switched. Specifically, the content of the projection image P to be displayed is switched. When the projector 3 has multiple video source input terminals, the video source is cyclically switched each time operation button 44 is clicked.

Automatic adjustment is a function of adjusting the angle of view of the projector 3 to a rectangular shape, and one operation button 45 is provided corresponding to this function. The operation button 45 is an automatic adjustment button.

When the operation button 45 is clicked, adjustment of the field of view begins, and when adjustment of the field of view is completed, the device returns to the startup state.

The operation panel 4 may be a touch panel. In this case, various icons for operation are displayed on the display screen as the operation buttons 41, 42a, 42b, 43, 44, and 45. The user can execute operations related to the above-described five types of functions by tapping or long-pressing the icons.

It is preferable that the number of types of functions that can be operated on operation panel 4 be one or more and five or less. By setting the number of types of functions that can be operated on the operation panel 4 to one or more and five or less, a simple and intuitive operation can be achieved.

When the number of types of functions that can be operated on the operation panel 4 is four or less, necessary functions may be selected from the above-described five types of functions of power supply, volume adjustment, mute, video source switching, and automatic adjustment. Functions other than the five types described above may be selected as functions that can be operated on the operation panel 4.

Although a plurality of functions are assigned to each of the operation buttons 41, 42a, 42b, 43, 44, and 45, the type of function that can be operated by each of the operation buttons 41, 42a, 42b, 43, 44, and 45 is a single type. For example, two functions, i.e., a function of turning on the power supply and a function of turning off the power supply, are assigned to the operation button 41, but both of the functions are related to the power supply, and the type of function is a single type.

In this way, by assigning only one type of function to each of the operation buttons 41, 42a, 42b, 43, 44, and 45, a simple configuration can be achieved.

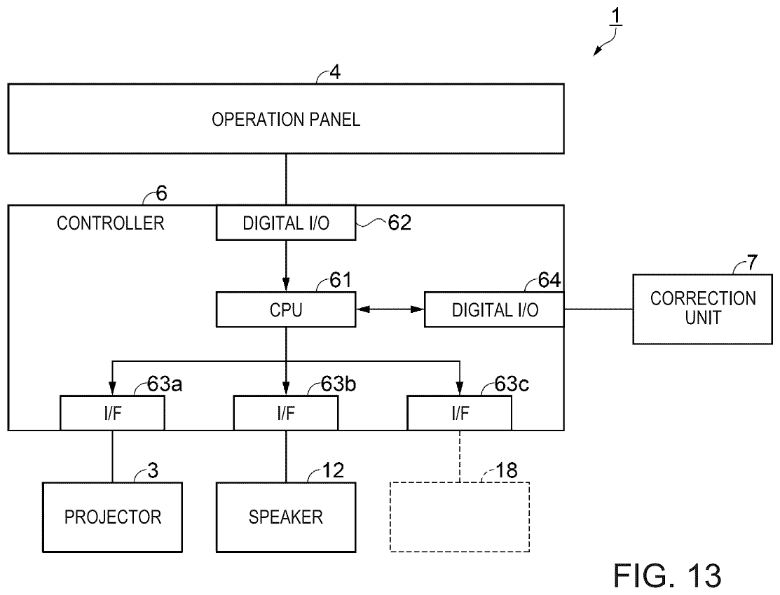

FIG. 13 is a block diagram showing a configuration of the controller 6. The controller 6 includes a central processing unit (CPU) 61, a digital input/output (I/O) port 62, a plurality of interfaces (I/Fs) 63a, 63b, and 63c, and a digital I/O port 64.

An operation panel 4 is connected to the digital I/O port 62 via a cable. The projector 3 is connected to the I/F 63a, and the speaker 12 is connected to the I/F 63b. Another device 18 may be connected to the I/F 63c. The correction unit 7 is connected to the digital I/O port 64.

The CPU 61 controls the projector 3 and/or the speaker 12 based on the operation signal from the operation panel 4. The correction unit 7 includes sensors such as an illumination sensor, and the CPU 61 corrects the projection brightness or the like of the projector 3 to an appropriate value based on a signal from the correction unit 7.

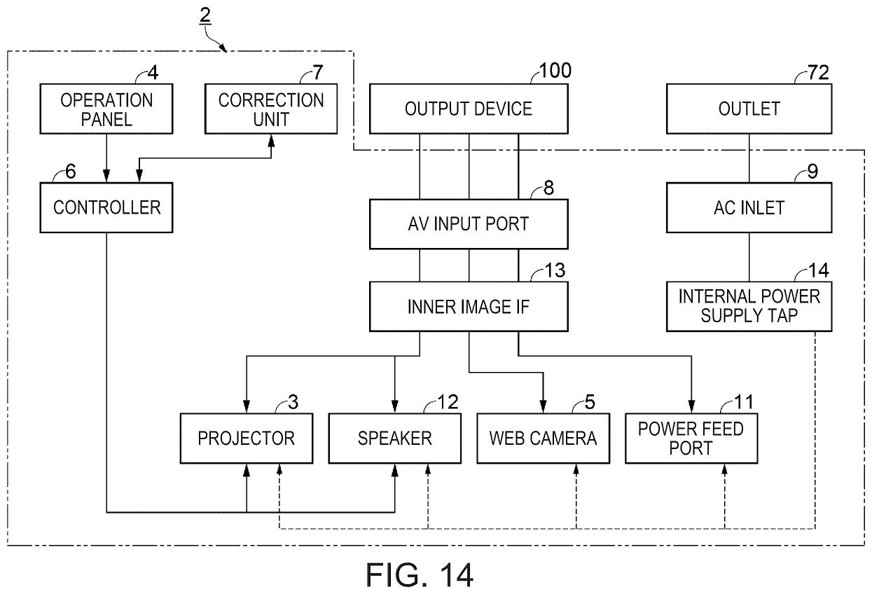

FIG. 14 is a diagram showing an example of the cabling of the projection cabinet 2.

In the projection cabinet 2 of the present embodiment, the cabinet main body 10 packages the projector 3 and, in addition the operation panel 4, the Web camera 5, the controller 6, the correction unit 7, the AV input port 8, the AC inlet 9, the power feed port 11, the speaker 12, the inner image IF 13, and the internal power supply tap 14.

The projection cabinet 2 is stored in a pre-cabled state as shown in FIG. 14 so as to be ready for use.

Next, an example of a case of using the projection cabinet 2 will be described.

The user moves the projection cabinet 2 to a conference room and installs the projection cabinet 2 at a predetermined projection position. At this time, the user can easily install the projection cabinet 2 at a predetermined projection position simply by bringing the protrusion 21p of the projection cabinet 2 into contact with the wall surface W of the conference room.

The user connects a power cable to the AC inlet 9 of the projection cabinet 2, and connects the power cable to the outlet 72. The user connects the output device 100 to the AV input port 8.

The user clicks the operation button 41 of the operation panel 4 to activate the projector 3 and the speaker 12.

The user adjusts the angle of view of the projector 3 by clicking the operation button 45.

The user operates the operation button 42a or the operation button 42b to adjust the volume. When the video source is not the desired source, the user operates the operation button 44 to change the video source to the desired source.

When the use of the projection cabinet 2 is finished, the user clicks the operation button 41 to turn off the projector 3 and the speaker 12.

The user removes the power cable and the user's output device 100 from the projection cabinet 2 and clears the projection cabinet 2.

As described above, the projection system 1 according to the present embodiment includes the projector 3 that emits projection light Lp, serving as the projection image, to be projected on the wall surface W, serving as the projection surface, the projection cabinet 2 that houses the projector 3, and the holding member 50 on which the output device 100 is placed. The projection cabinet 2 includes the cabinet main body 10 having a projection port 31 arranged in accordance with the configuration of the projector 3 and a first hole 29a for a user to grasp the projection cabinet 2, and a lower assembly 20 arranged in the cabinet main body 10 and in which the projector 3 is installed. The holding member 50 is detachably attached to the projection port 31.

According to the projection system 1 of the present embodiment, it is possible to easily attach the holding member 50 to the cabinet main body 10 using the projection port 31. In the projection system 1 according to the present embodiment, since the output device 100 placed on the holding member 50 can be directly accessed and operated, it is possible to improve the operability of the system by the user.

In the projection system 1 according to the present embodiment, since the projection port 31 disposed in accordance with the configuration of the projector 3 is also used to attach the holding member 50, it is not necessary to individually form an opening for attaching the holding member 50 in the cabinet main body 10. Therefore, the projection system 1 according to the present embodiment can suppress that the design appearance of the cabinet main body 10 becomes impaired due to an increase in the number of openings.

The projection system 1 according to the present embodiment enables placement of an object on the holding member 50 even when the object cannot be placed on the upper assembly 30. In the projection system 1 according to the present embodiment, the holding member 50 is configured to be attachable to and detachable from the cabinet main body 10. Therefore, for example, the size of the cabinet main body 10 can be reduced as compared with a configuration in which the holding member is used by being pulled out from the cabinet main body.

In the projection system 1 according to the present embodiment, the protrusion 21p is brought into contact with the wall surface W, to position the projector 3 at a predetermined position at which the projection image P is displayed on the wall surface W.

Therefore, the reliability of the alignment accuracy can be improved.

In the projection cabinet 2 according to the present embodiment, the lower assembly 20 as the installation section has a base 21 on which the projector 3 is placed, and the protrusion 21p as a protrusion section is a part of the base 21. It should be noted that the protrusion section exemplified by the protrusion 21p is not limited to being configured as a part of the base 21, and may be configured as, for example, a member in which resin, rubber, or the like are installed at the tip of a protrusion extending from the base 21. That is, the protrusion section may be configured to include a protrusion, resin, rubber, or the like.

In this way, the protrusion 21p is a part of the base 21. In other words, the component provided between the wall surface W as the projection surface and the projector 3 is only a single point of the base 21.

Therefore, it is possible to reduce the possibility of manufacturing variations and assembly errors. Furthermore, it is also possible to suppress the possibility of rattling due to use or aging.

In the projection cabinet 2 of the present embodiment, the base 21 has the through holes 21a disposed at positions corresponding to intake ports provided in the projector 3, and the cabinet main body 10 as the housing has the cutout 33 disposed at a position corresponding to the exhaust port 3e provided in the side surface intersecting the bottom surface of the projector 3.

As described above, the projection cabinet 2 according to the present embodiment has an opening at a position corresponding to the ventilation port of the projector 3.

Therefore, the projection cabinet 2 can favorably maintain the ventilation of the projector 3 housed within, and the projector 3 can be operated stably.

The projection cabinet 2 of the present embodiment further includes handles 29 constituted by a first hole 29a that is provided in the cabinet main body 10 as a housing, and a second hole 29b that is provided in the base 21 and that communicates with the first hole 29a via an accommodation space 20s as a space in the cabinet main body 10.

As described above, the projection cabinet 2 has the handles 29 including the first hole 29a and the second hole 29b. Therefore, the projection cabinet 2 can be easily transported.

In the projection cabinet 2 according to the present embodiment, the base 21 has the fixing sections 21c for fixing the projector 3.

Therefore, it is possible to suppress the occurrence of deviation in the installation position of the projector 3 due to transportation of projection cabinet 2 or the like.

The projection cabinet 2 of the present embodiment includes the operation panel 4 that is disposed in the cabinet main body 10 as a housing and that has the operation buttons 41, 42a, 42b, 43, 44, and 45 as a plurality of operation elements. The types of functions operated by these operation buttons 41, 42a, 42b, 43, 44, and 45 range from one or more to five or less.

Therefore, the user can simply and intuitively operate the operation panel 4.

In the projection cabinet 2 according to the present embodiment, the operation buttons 41, 42a, 42b, 43, 44, and 45 serving as a plurality of operation elements each has one type of function to be operated.

In this way, by assigning only one type of function to each of the operation buttons 41, 42a, 42b, 43, 44, and 45, it is possible to simplify the configuration of the operation panel 4. In the first embodiment, the case where the first hole 29a is used as the opening for attaching the holding member 50 has been described as an example, but the opening for attaching the holding member 50 is not limited to this. For example, the opening 32 and the cutouts 33 and 34 may be used as the opening for attaching the holding member 50.

### Second Embodiment

Next, a second embodiment of the projection system will be described with reference to the drawings. This embodiment differs from the first embodiment in the attachment position of the holding member. Hereinafter, configuration of the holding member and configuration of the opening section to which the holding member is attached will be mainly described. Components and members common to those of the first embodiment are denoted by the same reference numerals, and detailed description thereof will be omitted.

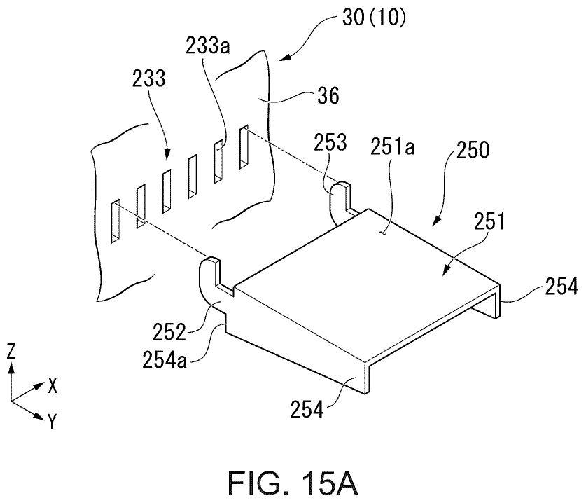

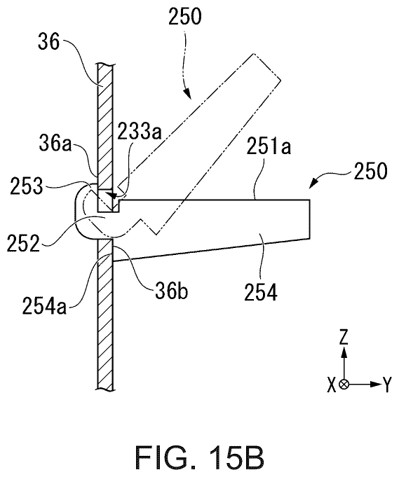

FIG. 15A is a perspective view showing schematic configuration of a holding member 250 of the second embodiment. FIG. 15B is a cross-sectional view showing a state where the holding member 250 is attached to the cabinet main body 10. It should be noted that peripheral configuration of the cabinet main body 10 to which the holding member 250 is attached is also shown in FIG. 15A.

As shown in FIGS. 15A and 15B, the holding member 250 of the present embodiment is detachably attached to a slit section 233 provided in the right side plate 36 of the upper assembly 30. The slit section 233 has a plurality of slits 233a penetrating the right side plate 36. The slit section 233 is an exhaust port through which passes exhaust air that is discharged after cooling a heat source, such as a light source, disposed in the projector 3 housed in the cabinet main body 10. That is, the slit section 233 is an opening section disposed in accordance with a function of the projector 3, and in the present embodiment, the slit section 233 is an example of a first opening.

In the case of the present embodiment, since the slit section 233 including the plurality of slits 233a is used as the exhaust port instead of one large opening, it is possible to suppress the entry of dust and foreign matter into the cabinet main body 10.

The holding member 250 includes a holding section 251, an insertion section 252, a first latching section 253, and a second latching section 254. The holding member 250 is formed of one metal plate that was subjected to a bending process. If necessary, a through hole port penetrating the holding surface 251a of the holding section 251 may be provided.

To be more specific, the holding section 251 is formed of a rectangular plate material and has a holding surface 251a on which the output device 100 is placed.

The second latching section 254 is formed of a substantially trapezoidal plate member in which portions connected to both ends of the holding section 251 in the X-axis direction are bent to the −Z side. The second latching section 254 is provided on the −Z side with respect to the holding surface 251a, and abuts on the outer wall 36b of the right side plate 36 on the proximal side of the insertion section 252. The −Z side portion of a side surface 254a of the second latching section 254 abuts on the outer wall 36b of the right side plate 36.

Here, contact between the second latching section 254 and the outer wall 36b is not limited to a mode in which the second latching section 254 and the outer wall 36b are completely in contact with each other while the holding member 250 is attached to the slit section 233, and includes a mode in which the second latching section 254 and the outer wall 36b are disposed to face each other with a predetermined space therebetween.

The insertion section 252 extends from the holding section 251 along the Y-axis direction, which is along the holding surface 251a, and is inserted into one slit 233a of the slit section 233. The insertion section 252 is constituted by a protruding piece that protrudes in the Y-axis direction from the side surface 254a forming a lower base of the trapezoidal second latching section 254.

The first latching section 253 extends from the distal end of the insertion section 252 along the Z-axis direction, which intersects the holding surface 251a, and abuts against an inner wall 36a of the right side plate 36.

Here, contact between the first latching section 253 and the inner wall 36a is not limited to a mode in which the first latching section 253 and the inner wall 36a are completely in contact with each other while the holding member 250 is attached to the slit section 233, and includes a mode in which the first latching section 253 and the inner wall 36a are disposed to face each other with a predetermined space therebetween.

In this embodiment, an end portion of the insertion section 252 on the −Z side and an end portion of the first latching section 253 on the +Z side are chamfered. Accordingly, since interference between the first latching section 253 and the insertion section 252, and the opening end of the slit 233a is suppressed, it is possible to improve the mountability of the holding member 250 with respect to the slit 233a.

Note that in the present embodiment, the inner wall 36a of the right side plate 36 corresponds to the inner wall of the housing, and the outer wall 36b of the right side plate 36 corresponds to the outer wall of the housing.

Next, a case where the holding member 250 is attached to the slit section 233 will be described.

As indicated by two dot chain line in FIG. 15B, the first latching section 253 and the insertion section 252 are inserted into an arbitrary slit 233a in a state where the holding surface 251a of the holding section 251 is inclined toward the inside of the cabinet main body 10, and then the holding section 251 is returned to the horizontal state. By this, the vertically raised first latching section 253 abuts against the inner wall 36a of the right side plate 36, and the side surface 254a of the second latching section 254 abuts against the outer wall 36b of the right side plate 36. In this way, as indicated by solid line in FIG. 15B, the holding member 250 is attached to the upper assembly 30 by the first latching section 253 being latched to the inner wall 36a of the right side plate 36 and the second latching section 254 being latched to the outer wall 36b of the right side plate 36.

On the other hand, when the holding member 250 is to be removed, the holding section 251 is inclined to approach the outer wall 36b of the right side plate 36, causing the first latching section 253 to separate from the inner wall 36a of the right side plate 36 and the second latching section 254 to separate from the outer wall 36b of the right side plate 36, and then the first latching section 253 and the insertion section 252 are pulled out from the slit 233a. By this, the holding member 250 can be easily removed from the upper assembly 30.

According to the projection system of the present embodiment, it is possible to easily attach the holding member 250 to the cabinet main body 10 by using the slit section 233 provided corresponding to the exhaust port of the projector 3. Therefore, also in the projection system of the present embodiment, similarly to projection system 1 of the first embodiment, the operability of the system can be improved without impairing the design appearance of the cabinet main body 10.

Note that in the present embodiment, the case where the slit section 233 is an exhaust port was described as an example, but the slit section 233 may also correspond to an intake port through which passes air for cooling a heat source disposed in the projector. In this case, a configuration in which the holding member 250 can be attached to and detached from the slit section constituting the intake port may be adopted. According to this configuration, since the holding member 250 can be easily attached to the cabinet main body 10 by using the slit section provided in correspondence with the intake port of the projector, the operability of the system can be improved without impairing the design appearance of the cabinet main body 10.

### Third Embodiment

Next, a third embodiment of the projection system will be described with reference to the drawings. This embodiment differs from the first embodiment in the attachment position of the holding member. Hereinafter, the configuration of the holding member will be mainly described. Components and members common to those of the first embodiment are denoted by the same reference numerals, and detailed description thereof will be omitted.

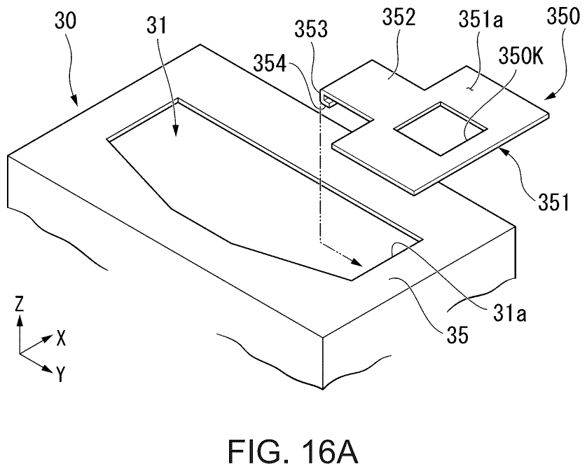

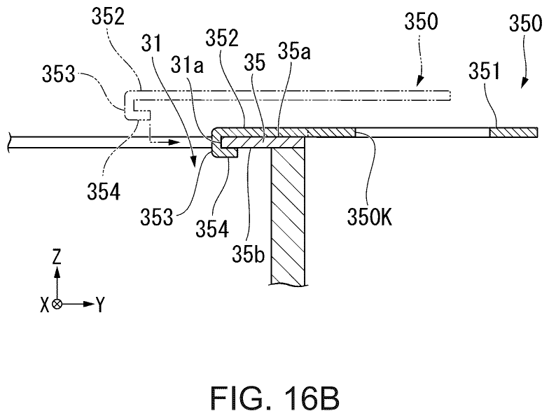

FIG. 16A is a perspective view showing schematic configuration of a holding member 350 of the third embodiment. FIG. 16B is a cross-sectional view showing a state where the holding member 350 is attached to the cabinet main body 10. It should be noted that peripheral configuration of the cabinet main body 10 to which the holding member 350 is attached is also shown in FIG. 16A.

As shown in FIGS. 16A and 16B, the holding member 350 of the present embodiment is detachably attached to the projection port 31 provided in the top plate 35, which forms the upper surface of the upper assembly 30. The holding member 350 is attached to a side of an inner circumferential edge 31a of the projection port 31, when the wall surface W, which is the projection surface, is viewed from the front surface side of the inner circumferential edge 31a. In the case of the present embodiment, it is attached to the right side (+Y side) of the inner circumferential edge 31a of the projection port 31.

The holding member 350 includes a holding section 351, a first latching section 352, a second latching section 353, and a third latching section 354. The holding member 350 is configured by a single metal plate that has undergone a bending process. The holding section 351 includes a holding surface 351a on which the output device 100 is placed and held, and a rectangular through hole port 350K penetrating through the holding surface 351a. The through hole port 350K may be omitted if necessary.

The first latching section 352 is formed from a plate member that extends from the holding section 351 along the Y-axis direction, which is along the holding surface 351a, and abuts against the outer wall 35a of the top plate 35 of the upper assembly 30. In the present embodiment, the outer wall 35a of the top plate 35 is an example of the outer wall of the housing.

The second latching section 353 is formed of a plate member that extends from the first latching section 352 along the Z-axis direction, which intersects the holding surface 351a, and that is bent in a U shape to come into contact with the inner circumferential edge 31a of the projection port 31.

The third latching section 354 is constituted by a plate member that extends from the second latching section 353 along the Y-axis direction, which is along the holding surface 351a, and that abuts against the inner wall 35b of the top plate 35 of the upper assembly 30. In the present embodiment, the inner wall 35b of the top plate 35 is an example of an inner wall of the housing.

Next, a case where the holding member 350 is attached to the projection port 31 will be described.

As indicated by two dot chain line in FIG. 16B, the holding member 350 is placed on the top plate 35 in a state where the third latching section 354 is positioned inside an opening end of the projection port 31, and the first latching section 352 is brought into contact with the outer wall 35a of the top plate 35. Then, by moving the holding member 350 toward outside of the projection port 31, the second latching section 353 comes into contact with the inner circumferential edge 31a of the projection port 31, and the third latching section 354 comes into contact with the inner wall 35b of the top plate 35. In this way, as shown by solid line in FIG. 16B, the holding member 350 is attached to the cabinet main body 10 by the first latching section 352 being latched to the outer wall 35a of the top plate 35, the second latching section 353 being latched to the inner circumferential edge 31a of the projection port 31, and the third latching section 354 being latched to the inner wall 35b of the top plate 35.

On the other hand, when the holding member 350 is to be detached, the holding section 351 is slid to the inner side of the projection port 31 to separate the second latching section 353 from the inner circumferential edge 31a of the projection port 31 and to separate the third latching section 354 from the inner wall 35b of the top plate 35, and then the holding member 350 is horizontally lifted upward. By this, the holding member 350 can be easily removed from the cabinet main body 10.

According to the projection system of the present embodiment, it is possible to easily attach the holding member 350 to the cabinet main body 10 by using the projection port 31 provided corresponding to the projection light Lp of the projector 3. Therefore, also in the projection system of the present embodiment, similarly to the projection system of the above-described embodiments, the operability of the system can be improved without impairing the design appearance of the cabinet main body 10.

The technical scope of the present disclosure is not limited to the above-described embodiments, and various modifications can be made without departing from the spirit of the present disclosure.

In addition, the specific description of the shape, the number, the arrangement, the material, and the like of each component of the light source device and the projector is not limited to the embodiment described above and can be appropriately changed.

A summary of the present disclosure is noted below.

### First Note

A projection system includes a projector that emits light as a projection image to be projected on a projection surface; a projection cabinet housing the projector; and a holding member on which an object is placed, wherein the projection cabinet includes a housing with a first opening arranged in accordance with configuration of the projector and a second opening for a user to grip the projection cabinet and an installation section disposed in the housing and on which the projector is installed and the holding member is detachably attached to at least one of the first opening or the second opening.

According to the projection system having this configuration, it is possible to easily attach the holding member to the housing by using at least one of the first opening arranged in accordance with the configuration of the projector and the second opening provided for gripping the projection cabinet. In the projection system, for example, since it is possible to directly access an object that is mounted on the holding member, such as an output device that outputs a signal to the projector, it is possible to improve the operability of the system by the user.

In this projection system, since the first opening or the second opening is also used to attach the holding member, it is not necessary to separately form an opening in the cabinet for attaching the holding member. Therefore, it is possible to prevent the design appearance of the projection cabinet from being impaired due to an increase in the number of openings.

In this projection system, even when the object cannot be placed on the housing, the object can be placed on the holding member. Since a configuration in which the holding member is attachable to and detachable from the housing is adopted, for example, the size of the housing can be reduced compared to a configuration in which the holding member is used by being pulled out from the housing.

### Second Note

The projection system according to the first note, wherein the first opening is an intake port through which air is taken into the projector and passed through the projector to cool a heat source disposed in the projector and the holding member is detachably attached to the intake port.

According to this configuration, since it is possible to easily attach the holding member to the housing by using the first opening provided corresponding to the intake port of the projector, it is possible to improve the operability of the system without impairing the design appearance of the projection cabinet.

### Third Note

The projection system according to the first note, wherein the first opening is an exhaust port through which passes exhaust air that cooled a heat source disposed in the projector and the holding member is detachably attached to the exhaust port.

According to this configuration, since the holding member can be easily attached to the housing using the first opening provided corresponding to the exhaust port of the projector, it is possible to improve the operability of the system without impairing the design appearance of the projection cabinet.

### Fourth Note

The projection system according to the second note or the third note, wherein the holding member includes a holding section having a holding surface on which the object is placed and held, an insertion section that extends from the holding section in a direction along the holding surface and that is inserted into at least one of the first opening or the second opening, a first latching section that extends from the insertion section along a direction intersecting the holding surface and that abuts against an inner wall of the housing, and a second latching section that is provided on a side opposite from the side from which the first latching section extends with respect to the holding surface and that abuts against an outer wall of the housing on a proximal side of the insertion section.

According to this configuration, since the first latching section is latched to the inner wall of the housing and the second latching section is latched to the outer wall of the housing, it is possible to attach the holding member, on which the object is placed on the holding surface, to the intake port or the exhaust port provided in the housing in a simple and stable state.

### Fifth Note

The projection system according to the fourth note, wherein the holding member has a through hole port that is provided in the holding section and that penetrates through the holding surface.

According to this configuration, by exposing the bottom surface side of the object placed on the holding surface, for example, a cable drawn out from the object can be inserted. The heat radiation property of the object can be improved by the through hole port.

### Sixth Note

The projection system according to any of first note to the third note, wherein the at least one of the first opening or the second opening to which the holding member is attached is disposed on a side of the housing with the projection surface as a front surface.

According to this configuration, when the holding member is attached, the holding member is positioned on the side of the projection cabinet. This helps prevent issues such as the holding member being located between the projection surface and the projection cabinet, or the holding member being located between the projection cabinet and the user, thereby becoming an obstruction.

### Seventh Note

The projection system according to any one of the first note to the sixth note, wherein the holding member is constituted by a single metal plate that has been subjected to a bending process.

According to this configuration, the weight and cost of the holding member can be reduced.

### Eighth Note

The projection system according to the first note, wherein the first opening is a projection port through which light emitted from the projector passes and the holding member is detachably attached to the projection port.

According to this configuration, since the holding member can be easily attached to the housing by using the first opening provided corresponding to the projection port of the projector, it is possible to improve the operability of the system without impairing the design appearance of the projection cabinet.

### Ninth Note

The projection system according to the eighth note, wherein the holding member includes a holding section having a holding surface on which the object is placed, a first latching section that extends from the holding section in a direction along the holding surface and that abuts against the outer wall of the housing, a second latching section that extends from the first latching section along a direction intersecting the holding surface and that abuts an inner circumferential edge of the projection port, and a third latching section that extends from the second latching section in a direction along the holding surface and that abuts against an inner wall of the housing.

According to this configuration, since the first latching section is latched to the outer wall of the housing, the second latching section is latched to the inner circumferential edge of the projection port, and the third latching section is latched to the inner wall of the housing, it is possible to attach the holding member, on which the object is placed on the holding surface, to the projection port provided in the housing in a simple and stable state.

### Tenth Note

The projection system according to the ninth note, wherein the holding member has a through hole port that is provided in the holding section and that penetrates through the holding surface.

According to this configuration, by exposing the bottom surface side of the object placed on the holding surface, for example, a cable drawn out from the object can be inserted. The heat radiation property of the object can be improved by the through hole port.

### Eleventh Note

The projection system according to any one of note 8 to note 10, wherein amongst inner circumferential edges of the projection port, the holding member is attached to an inner circumferential edge on a side when the projection surface is viewed from the front surface.

According to this configuration, when the holding member is attached, the holding member is positioned on the side of the projection cabinet. This helps prevent issues such as the holding member being located between the projection surface and the projection cabinet, or the holding member being located between the projection cabinet and the user, thereby becoming an obstruction.

### Twelfth Note

The projection system according to any one of note 8 to note 10, wherein the holding member is constituted by a single metal plate that has been subjected to a bending process.

According to this configuration, the weight and cost of the holding member can be reduced.

What is claimed is:

1. A projection system comprising:
a projector that emits light as a projection image to be projected on a projection surface;
a projection cabinet housing the projector; and
a holding member on which an object is placed, wherein
the projection cabinet includes
a housing with a first opening arranged in accordance with configuration of the projector and a second opening for a user to grip the projection cabinet and
an installation section disposed in the housing and on which the projector is installed and
the holding member is detachably attached to at least one of the first opening or the second opening.

2. The projection system according to claim 1, wherein
the first opening is an intake port through which air is taken into the projector and passed through the projector to cool a heat source disposed in the projector and
the holding member is detachably attached to the intake port.

3. The projection system according to claim 1, wherein
the first opening is an exhaust port through which passes exhaust air that cooled a heat source disposed in the projector and
the holding member is detachably attached to the exhaust port.

4. The projection system according to claim 2, wherein
the holding member includes
a holding section having a holding surface on which the object is placed and held,
an insertion section that extends from the holding section in a direction along the holding surface and that is inserted into at least one of the first opening or the second opening,
a first latching section that extends from the insertion section along a direction intersecting the holding surface and that abuts against an inner wall of the housing, and
a second latching section that is provided on a side opposite from the side from which the first latching section extends with respect to the holding surface and that abuts against an outer wall of the housing on a proximal side of the insertion section.

5. The projection system according to claim 4, wherein
the holding member has a through hole port that is provided in the holding section and that penetrates through the holding surface.

6. The projection system according to claim 1, wherein
the at least one of the first opening or the second opening to which the holding member is attached is disposed on a side of the housing with the projection surface as a front surface.

7. A projection system according to claim 1, wherein
the holding member is constituted by a single metal plate that has been subjected to a bending process.

8. The projection system according to claim 1, wherein
the first opening is a projection port through which light emitted from the projector passes and
the holding member is detachably attached to the projection port.

9. The projection system according to claim 8, wherein
the holding member includes
a holding section having a holding surface on which the object is placed,
a first latching section that extends from the holding section in a direction along the holding surface and that abuts against the outer wall of the housing,
a second latching section that extends from the first latching section along a direction intersecting the holding surface and that abuts an inner circumferential edge of the projection port, and
a third latching section that extends from the second latching section in a direction along the holding surface and that abuts against an inner wall of the housing.

10. The projection system according to claim 9, wherein
the holding member has a through hole port that is provided in the holding section and that penetrates through the holding surface.

11. A projection system according to claim 8, wherein
amongst inner circumferential edges of the projection port, the holding member is attached to an inner circumferential edge on a side when the projection surface is viewed from the front surface.

12. A projection system according to claim 8, wherein
the holding member is constituted by a single metal plate that has been subjected to a bending process.
